(19) United States
(12) Patent Application Publication
(10) Pub. No.: US 2025/0135446 A1
(43) Pub. Date: May 1, 2025

(54) Catalyst for Reforming Methane and Method for Producing Same

(71) Applicant: LG Chem, Ltd., Seoul (KR)

(72) Inventors: Sojin Kim, Daejeon (KR); Jun Yeon Cho, Daejeon (KR); Sangjin Kim, Daejeon (KR); Suji Kim, Daejeon (KR); Yongseon Kim, Daejeon (KR); Jae Soon Choi, Daejeon (KR); Jun Seon Choi, Daejeon (KR); Hyun A Choi, Daejeon (KR)

(73) Assignee: LG Chem, Ltd., Seoul (KR)

(21) Appl. No.: 18/834,438

(22) PCT Filed: Sep. 22, 2023
(86) PCT No.: PCT/KR2023/014479

§ 371 Date: Jul. 30, 2024

(30) Foreign Application Priority Data
Nov. 4, 2022 (KR) 10-2022-0146236

(51) Int. Cl. B01J 35/00; B01J 23/00; B01J 23/02; B01J 23/78; B01J 23/86; B01J 37/00; B01J 37/02; C01B 3/40

(52) U.S. Cl. CPC B01J 35/19; B01J 23/002; B01J 23/02; B01J 23/78; B01J 23/866; B01J 37/0018; B01J 37/0225; B01J 37/0228; B01J 37/0244; C01B 3/40; B01J 2523/24; B01J 2523/36; B01J 2523/47; B01J 2523/821; B01J 2523/847; C01B 2203/0238; C01B 2203/1058; C01B 2203/1082; C01B 2203/1241

(57) ABSTRACT

Provided are a catalyst for methane reformation and a method for manufacturing the same, wherein the catalyst includes a porous metal support; a primary coating layer provided on the porous metal support; and a secondary coating layer provided on the primary coating layer, wherein the primary coating layer includes a perovskite-based compound having a coefficient of thermal expansion of 65% or greater compared to a coefficient of thermal expansion of the porous metal support, the secondary coating layer includes a perovskite-based catalyst particle and a perovskite-based binder, and the perovskite-based catalyst particle and the perovskite-based binder each independently include a compound represented by Chemical Formula 1,

Sr₁₋ₓAₓTi_{1-y}B_{y}O_{3-δ} [Chemical Formula 1]
wherein all the variables are described herein.

### CROSS-REFERENCE TO RELATED APPLICATIONS

This application is a national stage entry under 35 U.S.C. § 371 of International Application No. PCT/KR2023/014479 filed on Sep. 22, 2023, which claims priority from Korean Patent Application No. 10-2022-0146236 filed on Nov. 4, 2022, all the entire disclosure of which are incorporated herein by reference.

### TECHNICAL FIELD

The present application relates to a catalyst for methane reformation and a method for manufacturing the same.

### BACKGROUND ART

As part of efforts to reduce greenhouse gases caused by global warming, much research is underway on carbon dioxide conversion technologies. A carbon dioxide reforming reaction, one of the carbon dioxide conversion technologies, is a technology that produces a synthesis gas composed of hydrogen and carbon monoxide by reacting methane and carbon dioxide.

The synthesis gas is a material with high development value as a raw material for various downstream applications. As a method for industrially obtaining the synthesis gas (H₂/CO), a reforming reaction of natural gas may be largely divided into a steam reforming process, a carbon dioxide (CO₂) reforming process, a catalytic partial oxidation process, an autothermal reforming process, a tri-reforming process, such as the following Reaction Schemes 1 to 5, and the like.

CH₄+H₂O→3H₂+COΔH=226 kJ/mol [Reaction Scheme 1]

CH₄+CO₂→2H₂+2COΔH=261 kJ/mol[Reaction Scheme 2]

CH₄+0.5O₂→2H₂+COΔH=−44 kJ/mol [Reaction Scheme 3]

autothermal reforming:Reaction Scheme 1+Reaction Scheme 3 [Reaction Scheme 4]

tri-reforming:Reaction Scheme 1+Reaction Scheme 2+Reaction Scheme 3 [Reaction Scheme 5]

Meanwhile, various catalysts may be used for reforming activity in the reforming process. Among them, when noble metal catalysts are used in the reforming process, there is an advantage in that relatively less carbon deposition occurs compared to nickel-based catalysts, resulting in higher reaction efficiency, but there is a problem in that the economic efficiency deteriorates because the noble metal catalysts are expensive.

Accordingly, nickel catalysts, which are relatively inexpensive, are usually used in the reforming process. In particular, as the nickel catalyst, a catalyst in which nickel metal is supported on a support such as alumina is widely used as a commercial catalyst. However, in such a case, there is a problem in that the nickel catalyst is deactivated by carbon that is inevitably produced on a surface of the nickel catalyst.

Therefore, there is a need in the technical field to develop a catalyst that is resistant to carbon deposition and can be effectively applied to the methane reforming process.

### PRIOR ART DOCUMENT

Korean Patent Application Publication No. 10-2019-0076367

### Technical Problem

The present application has been made in an effort to provide a catalyst for methane reformation and a method for manufacturing the same.

### Technical Solution

An exemplary embodiment of the present application provides a catalyst for methane reformation, including: a porous metal support; a primary coating layer provided on the porous metal support; and a secondary coating layer provided on the primary coating layer, wherein the primary coating layer includes a perovskite-based compound with a coefficient of thermal expansion of 65% or greater compared to a coefficient of thermal expansion of the porous metal support, wherein the secondary coating layer includes a perovskite-based catalyst particle and a perovskite-based binder, and wherein the perovskite-based catalyst particle and the perovskite-based binder each independently include a compound represented by the following Chemical Formula 1.

In addition, another exemplary embodiment of the present application provides a method for manufacturing a catalyst for methane reformation, the method including: performing primary coating on a porous metal support with a first slurry including a perovskite-based compound with a coefficient of thermal expansion of 65% or greater compared to a coefficient of thermal expansion of the porous metal support; and
performing secondary coating with a second slurry including a perovskite-based catalyst particle and a perovskite-based binder after the primary coating, wherein the perovskite-based catalyst particle and the perovskite-based binder each independently include a compound represented by the following Chemical Formula 1.

Sr₁₋ₓAₓTi_{1-y}B_{y}O_{3-δ} [Chemical Formula 1]
in Chemical Formula 1,
A is Y, La or Ba,
B is Ni, Co, Fe, Mn, Cr, Mo, Ru or Rh,
x is 0≤x<1,
y is 0≤y<0.5,
δ is a value that satisfies balance, 0≤δ<1, and
the x and y satisfy x+y>0.

### Advantageous Effects

The catalyst for methane reformation according to an exemplary embodiment of the present application includes a perovskite-based compound with a coefficient of thermal expansion of 65% or greater compared to a coefficient of thermal expansion of a porous metal support, whereby reactivity of the porous metal support itself that can cause a side reaction or coke can be suppressed and adhesion of the catalyst component at high temperatures is improved.

In addition, the secondary coating layer may be formed in the form of perovskite nanoparticles by coating the perovskite-based catalyst particle component directly on the porous metal support without a separate binder. Accordingly, an active surface area of the catalyst for methane reformation can be increased.

Due to these characteristics, the active surface area of the catalyst for methane reformation is increased, good activity can be exhibited even at a high space velocity during a methane reforming reaction, and a long-term stable operation is possible without carbon deposition or sintering.

### DETAILED DESCRIPTION

Hereinafter, the present specification will be described in more detail.

Throughout the present specification, when a member is referred to as being “on” another member, the member can be in direct contact with another member or an intervening member may also be present.

In the present specification, when a part is referred to as “including” a certain component, it means that the part can further include another component, not excluding another component, unless explicitly described to the contrary.

In the present specification, “p to q” means a range of “p or more and q or less”.

In the present specification, the “coefficient of thermal expansion” refers to one value of lengths of a certain object stretched in three directions of an x-axis, a y-axis, and a z-axis when a temperature of the object is increased by 1° C. at temperatures of 25° C. to 800° C.

In the present specification, the “perovskite-based catalyst particle” refers to a catalyst in the form of particle rather than a sol among catalysts having a perovskite structure. That is, it means a state in which the catalyst is not dissolved in a separate solvent.

In the present specification, the “perovskite-based compound” refers to a compound that has a perovskite structure but does not function as a catalyst.

In the present specification, the “perovskite-based binder” refers to a material formed from the perovskite-based catalyst sol formed from a solution including a precursor of the perovskite-based compound and a solvent.

Currently, catalysts that are widely used in the field of reformers are mainly powder-type catalysts and pellet-type support catalysts. Although the powder-type catalyst may have excellent performance due to excellent dispersion degree of the catalyst, it is difficult to directly use the powder-type catalyst in the industry. For example, when a reformer is driven using the powder-type catalyst, the catalyst comes out together with a material produced after a reaction. In this case, a phenomenon may occur in which the catalyst in the form of powder gradually accumulates in a stream tube at an exit portion, and eventually, blocks the entire tube. Therefore, there is a disadvantage in that the powder-type catalysts cannot be used for commercial reformers used in the industry.

In addition, the pellet-type support catalyst is currently frequently used for industrial reformers. Due to limitations in mass transfer rate, the performance deteriorates compared to the powder-type catalyst only in terms of the catalyst performance, but there is an advantage in that the pellet-type support catalyst can be used for a long period of time because a support is used. However, a γ-Al₂O₃ pellet, which is often used as the pellet-type support catalyst, has a weak structural strength, and thus may be easily broken, and accordingly, there is a disadvantage in that a differential pressure is generated in a reactor. In addition, due to the characteristics of the pellet-type support catalyst, the volume is large, so when used for a high-capacity reformer, the volume becomes significantly larger. Further, all reforming reactions are sensitive to reaction temperature, but the existing pellet-type catalyst has a very low thermal conductivity, and thus, is disadvantageous in that heat is not evenly distributed throughout the reactor.

Accordingly, the present application has been intended to alleviate a phenomenon of blocking the stream tube, which is a disadvantage of the powder-type, and to improve the heat and mass transfer rates, which are a common disadvantage of the powder-type and the pellet-type, through a method of coating a porous metal support catalyst having high heat and mass transfer rates with a catalyst.

The porous metal support catalyst may be prepared by coating a surface of a porous metal support with a slurry prepared by mixing a catalyst precursor or catalyst powder, a binder, an additive, and the like. In order to introduce catalyst particles onto the surface of the porous metal support, an organic binder and/or an inorganic binder may be added and used when preparing the slurry. The organic binder remains in the slurry until drying and firing processes and can contribute to reduction in surface tension and stabilization of the slurry. The inorganic binder remains between catalyst particles or between catalyst particles and the porous metal support after the firing process to serve to fix the catalyst particles on the porous metal support, and may be usually used by adding silica, alumina sol or colloidal form. When a large amount of the inorganic binder is used, there is an advantage of strengthening a bond between the catalyst particles and the porous metal support. However, on the other hand, the presence of a large amount of binder on the surface of the catalyst particle may reduce the number of reaction sites, and the binder may affect the catalyst phase. At the same time, the binder may also participate in the reaction to induce undesired side reactions. Accordingly, the catalyst precursor is directly used for the purpose of immediately introducing the catalyst onto the porous metal support without a binder in some cases. However, in this case, there is a disadvantage in that an amount of catalyst supported at one time is small.

Accordingly, the present application intends to provide a catalyst for methane reformation capable of supporting a large amount of catalyst at one time and suppressing side reactions caused by a binder.

An exemplary embodiment of the present application provides a catalyst for methane reformation, including: a porous metal support; a primary coating layer provided on the porous metal support; and a secondary coating layer provided on the primary coating layer, wherein the primary coating layer includes a perovskite-based compound with a coefficient of thermal expansion of 65% or greater compared to a coefficient of thermal expansion of the porous metal support, wherein the secondary coating layer includes a perovskite-based catalyst particle and a perovskite-based binder, and wherein the perovskite-based catalyst particle and the perovskite-based binder each independently include a compound represented by the following Chemical Formula 1.

Sr₁₋ₓAₓTi_{1-y}B_{y}O_{3-δ} [Chemical Formula 1]
in Chemical Formula 1,
A is Y, La or Ba,
B is Ni, Co, Fe, Mn, Cr, Mo, Ru or Rh,
x is 0≤x<1,
y is 0≤y<0.5,
δ is a value that satisfies balance, 0≤δ<1, and
the x and y satisfy x+y>0.

The catalyst for methane reformation according to the present application includes, on a coating layer, a perovskite-based compound with a coefficient of thermal expansion of 65% or greater compared to a coefficient of thermal expansion of a porous metal support, whereby reactivity of the porous metal support itself that can cause a side reaction or coke can be suppressed and adhesion of the catalyst component at high temperatures can be improved.

In addition, the secondary coating layer may be formed in the form of perovskite nanoparticles by coating the perovskite-based catalyst particle component directly on the porous metal support without a separate binder. Accordingly, an active surface area of the catalyst for methane reformation can be increased.

Due to these characteristics, the active surface area of the catalyst for methane reformation is increased, good activity can be exhibited even at a high space velocity during a methane reforming reaction, and a long-term stable operation is possible without carbon deposition or sintering.

In an exemplary embodiment of the present application, the primary coating layer may include a perovskite-based compound with a coefficient of thermal expansion of 65% or greater compared to a coefficient of thermal expansion of the porous metal support.

In an exemplary embodiment of the present application, the coefficient of thermal expansion of the perovskite-based compound of 65% or greater compared to the coefficient of thermal expansion of the porous metal support may satisfy the following equation 1.

$$10. \times {10}^{- 6} {K}^{- 1} \leq G 1 \leq 14. \times {10}^{- 6} {K}^{- 1} \qquad [ Equation 1 ]$$

In Equation 1 above, G1 refers to a coefficient of thermal expansion.

In an exemplary embodiment of the present application, G1 may be 10.0×10⁻⁶K⁻¹≤G1≤14.0×10⁻⁶K⁻¹, preferably, 10.0×10⁻⁶K⁻¹≤G1≤13.0×10⁻⁶K⁻¹.

In an exemplary embodiment of the present application, a content of the perovskite-based compound with the coefficient of thermal expansion of 65% or greater compared to the coefficient of thermal expansion of the porous metal support may be 1% by weight to 20% by weight or 1.5% by weight to 18% by weight based on a total weight of the catalyst for methane reformation. When the above content range is satisfied, the performance of the catalyst for methane reformation according to the present application can be further improved, such as suppressing reactivity of the porous metal support itself, which can cause side reactions or coke, and improving adhesion of the catalyst component at high temperatures.

Specifically, if the content of the perovskite-based compound with the coefficient of thermal expansion of 65% or greater compared to the coefficient of thermal expansion of the porous metal support exceeds 20% by weight, it is not desirable because the ability to coat the secondary coating layer (catalyst layer) may be reduced and the activity of the catalyst compared to the volume of the porous metal support may be lowered. In addition, if the content of the perovskite-based compound with the coefficient of thermal expansion of 65% or greater compared to the coefficient of thermal expansion of the porous metal support is less than 1% by weight, the content is so small that it may be difficult to obtain the effect of the primary coating layer.

In an exemplary embodiment of the present application, the perovskite-based compound with the coefficient of thermal expansion of 65% or greater compared to the coefficient of thermal expansion of the porous metal support may be represented by the following Chemical Formula 3.

Sr₁₋ₐYₐTiO_{3-δ} [Chemical Formula 3]
in Chemical Formula 3,
a is 0≤a<1, and
δ is a value that satisfies balance, and 0≤δ≤1.

In an exemplary embodiment of the present application, the perovskite-based compound with the coefficient of thermal expansion of 65% or greater compared to the coefficient of thermal expansion of the porous metal support may be the following Chemical Formula 3-1 or SrTiO₃.

Sr₁₋ₐYₐTiO_{3-δ} [Chemical Formula 3-1]
in Chemical Formula 3-1,
a is 0<a<1, and
δ is a value that satisfies balance, and 0≤δ<1.

In an exemplary embodiment of the present application, the Chemical Formula 1 may be represented by the following Chemical Formula 2.

Sr₁₋ₓYₓTi_{1-y}B_{y}O_{3-δ} [Chemical Formula 2]
in Chemical Formula 2,
B is Ni, Co, Fe, Mn, Cr, Mo, Ru or Rh,
x is 0≤x<0.3,
y is 0≤y<0.2,
δ is a value that satisfies balance, 0≤δ<1, and
the x and y satisfy x+y>0.

In an exemplary embodiment of the present application, B in Chemical Formula 2 may be Ni or Ru.

In an exemplary embodiment of the present application, the porous metal support may include a material that can maintain thermal stability at high temperatures of 800° C. or higher. More specifically, in an exemplary embodiment of the present application, the porous metal support may be made of a material that can maintain thermal stability at high temperatures of 800° C. or higher.

In an exemplary embodiment of the present application, the porous metal support may include one or more of NiCrAlFe, NiCrAl, stainless steel, or inconel. More specifically, in an exemplary embodiment of the present application, the porous metal support may be made of one or more of NiCrAlFe, NiCrAl, stainless steel, or inconel.

The porous metal support is a support having various shapes and has a small heat capacity and an excellent heat transfer ability, so it can be molded into a desired shape and used. The shape and size of the porous metal support are not particularly limited, and a porosity of the porous metal support may be 10% to 99%, and preferably 50% to 96%. An average pore size of the porous metal support may be 150 μm to 4,000 μm, 200 μm to 3,500 μm, or 400 μm to 3,000 μm. Most preferably, it may be 700 μm to 2,000 μm. The porous metal support can be appropriately manufactured by one skilled in the art using methods known in the art, taking into account the material, pore size, porosity, and the like of the porous metal support described above.

In an exemplary embodiment of the present application, a content of the perovskite-based catalyst particle and perovskite-based binder may be 3% by weight to 40% by weight, 6% by weight to 35% by weight, or 7% by weight to 30% by weight, based on a total weight of the catalyst for methane reformation. Based on the total weight of the catalyst for methane reformation, if the content of the perovskite-based catalyst particle and perovskite-based binder is less than 3% by weight, it is not desirable because the reactivity may decrease due to the relatively small number of active sites on the surface of the catalyst. In addition, if the content of the perovskite-based catalyst particle and perovskite-base binder exceeds 40% by weight, a relatively large amount of catalyst component compared to the porous metal support is contained, so that it is difficult to maintain the pore structure and it is not easy to combine the catalyst component and the porous metal support, resulting in a reduction in the practical benefit of the methane reforming reaction.

Here, the content of the perovskite-based catalyst particle and perovskite-based binder refers to a sum of a content of the perovskite-based catalyst particle and a content of the perovskite-based binder.

In an exemplary embodiment of the present application, at least a portion of the surface of the catalyst particle may include a protrusion shape. The protrusion shape may be spherical, elliptical, or a combination thereof, but is not limited thereto. Each of the protrusions may have an average diameter of 20 nm to 1 μm. The protrusions may cover the entire surface of the catalyst particle, or may cover only a portion of the surface of the catalyst particle.

In an exemplary embodiment of the present application, the perovskite-based binder is an inorganic binder, and may serve to fix the perovskite-based catalyst particle on the porous metal support. In addition, the perovskite-based binder may be present in the form of protrusion on the perovskite-based catalyst particle, thereby increasing a reaction surface area of the catalyst to improve the performance of the methane reforming reaction.

Further, according to an exemplary embodiment of the present application, by additionally applying the perovskite-based binder in addition to the perovskite-based catalyst particle, a content of catalyst that is supported when coated on the porous metal support once can be increased, as compared with a case where the catalyst particle is applied alone. Further, by applying the perovskite-based binder according to an exemplary embodiment of the present application, it is possible to prevent a side reaction or a catalyst phase change that may occur when applying silica or another colloidal inorganic binder, thereby improving the performance of the methane reforming reaction.

In an exemplary embodiment of the present application, the catalyst for methane reformation may be applied to a steam reforming process, a carbon dioxide (CO₂) reforming process, a catalytic partial oxidation process, an autothermal reforming process, a tri-reforming process or a mixed reforming process, and the methane reforming process is not particularly limited.

An exemplary embodiment of the present application provides a method for manufacturing a catalyst for methane reformation, the method including: performing primary coating on a porous metal support with a first slurry including a perovskite-based compound with a coefficient of thermal expansion of 65% or greater compared to a coefficient of thermal expansion of the porous metal support; and performing secondary coating with a second slurry including a perovskite-based catalyst particle and a perovskite-based binder after the primary coating, wherein the perovskite-based catalyst particle and the perovskite-based binder each independently include a compound represented by the Chemical Formula 1 above.

As described above, the method for manufacturing a catalyst for methane reformation according to an exemplary embodiment of the present application can manufacture a catalyst for methane reformation in which the reactivity of the porous metal support itself, which can cause side reactions or coke, is suppressed and the adhesion of the catalyst component is improved.

In addition, when forming the secondary coating layer, the perovskite-based catalyst particle component can be directly coated on the porous metal support without a separate binder, so the perovskite-based catalyst component can be formed in the form of nanoparticles. Accordingly, the active surface area of the catalyst for methane reformation manufactured according to the method for manufacturing a catalyst for methane reformation according to an exemplary embodiment of the present application can be increased.

Due to these characteristics, the manufactured catalyst for methane reformation has such features that the active surface area is increased, good activity can be exhibited even at a high space velocity during a methane reforming reaction, and a long-term stable operation is possible without carbon deposition or sintering.

In the method for manufacturing a catalyst for methane reformation according to an exemplary embodiment of the present application, details on the porous metal support, the perovskite-based compound, the perovskite-based catalyst particle, and the perovskite-based binder are the same as those described above.

In particular, the perovskite-based binder of the catalyst for methane reformation may be formed from the perovskite-based catalyst sol.

As described above, the perovskite-based catalyst sol may be formed from a solution including a precursor of the perovskite-based compound and a solvent. The precursor of the perovskite-based compound is a precursor of metal constituting the perovskite-based compound, and a metal molar ratio of the perovskite-based compound may be adjusted by adjusting the content thereof. In addition, the precursor of the metal is not particularly limited, and ammonium salts, nitrates, carbonates, chlorides, lactates, hydroxides, organic acid salts, oxides of the metal elements, or mixtures thereof may be applied in combination. The solvent is not particularly limited, and any solvent known in the art may be used. For example, as the solvent, water, an alcohol-based solvent, or the like may be applied, but the solvent is not limited thereto.

The method for manufacturing a catalyst for methane reformation according to an exemplary embodiment of the present application may further include preparing a first slurry including the perovskite-based compound with the coefficient of thermal expansion of 65% or greater compared to the coefficient of thermal expansion of the porous metal support.

In an exemplary embodiment of the present application, the first slurry may include the perovskite-based compound with the coefficient of thermal expansion of 65% or greater compared to the coefficient of thermal expansion of the porous metal support, in the form of powder.

In an exemplary embodiment of the present application, the first slurry may not include a binder. The binder may be an organic binder and/or an inorganic binder. That is, a binder may not be used for the purpose of directly introducing the perovskite-based compound with the coefficient of thermal expansion of 65% or greater compared to the coefficient of thermal expansion of the porous metal support onto the porous support.

In an exemplary embodiment of the present application, the first slurry may be mixed with an additive, in addition to the perovskite-based compound in the form of powder with the coefficient of thermal expansion of 65% or greater compared to the coefficient of thermal expansion of the porous metal support. As a type of additive, materials commonly used in the relevant field may be used.

In an exemplary embodiment of the present application, a content of the perovskite-based compound with the coefficient of thermal expansion of 65% or greater compared to the coefficient of thermal expansion of the porous metal support is 1% by weight to 20% by weight or 1.5% by weight to 18% by weight based on a total weight of the first slurry. When the above content range is satisfied, the performance of the catalyst for methane reformation according to the present application can be further improved, such as suppressing reactivity of the porous metal support itself, which can cause side reactions or coke, and improving adhesion of the catalyst component at high temperatures.

As described above, if the content of the perovskite-based compound with the coefficient of thermal expansion of 65% or greater compared to the coefficient of thermal expansion of the porous metal support exceeds 20% by weight, it is not desirable because the ability to coat the secondary coating layer (catalyst layer) may be reduced and the activity of the catalyst compared to the volume of the porous metal support may be lowered. In addition, if the content of the perovskite-based compound with the coefficient of thermal expansion of 65% or greater compared to the coefficient of thermal expansion of the porous metal support is less than 1% by weight, the content is so small that it may be difficult to obtain the effect of the primary coating layer.

The method for manufacturing a catalyst for methane reformation according to an exemplary embodiment of the present application may further include preparing the second slurry including the perovskite-based catalyst particle and the perovskite-based binder.

In an exemplary embodiment of the present application, the second slurry may include the perovskite-based catalyst particle in the form of powder. In an exemplary embodiment of the present application, the second slurry may include a binder. The binder may be an organic binder and/or an inorganic binder.

In an exemplary embodiment of the present application, the second slurry may be mixed with an additive, in addition to the perovskite-based catalyst particle and the perovskite-based binder. As a type of the additive, materials commonly used in the relevant field may be used.

The method for manufacturing a catalyst for methane reformation according to an exemplary embodiment of the present application includes performing primary coating on a porous metal support with a first slurry including a perovskite-based compound with a coefficient of thermal expansion of 65% or greater compared to a coefficient of thermal expansion of the porous metal support.

The method for manufacturing a catalyst for methane reformation according to an exemplary embodiment of the present application includes performing secondary coating with a second slurry including a perovskite-based catalyst particle and a perovskite-based binder after the primary coating.

In an exemplary embodiment of the present application, the step of preparing the second slurry including the perovskite-based catalyst particle and the perovskite-based binder includes producing the second slurry by mixing the perovskite-based catalyst particle and a perovskite-based catalyst sol. The above description can be applied to the perovskite-based catalyst sol, and in order to control a concentration of the second slurry, a solvent used in the preparation of the perovskite-based catalyst sol may be additionally added.

In the method for manufacturing a catalyst for methane reformation according to an exemplary embodiment of the present application, the step of performing primary coating with the first slurry and the step of performing secondary coating with the second slurry each include impregnating the porous metal support in the first slurry or second slurry. In this case, the method may further include removing excess slurry from the porous metal support.

In an exemplary embodiment of the present application, the step of performing primary coating with the first slurry may be a step of impregnating the porous metal support with the first slurry.

In an exemplary embodiment of the present application, the step of performing second coating with the second slurry may be a step of impregnating the porous metal support with the second slurry.

In an exemplary embodiment of the present application, a concentration of the perovskite-based binder represented by the Chemical Formula 1 above may be 0.05M to 1M, preferably 0.08M to 1M, more preferably 0.1M to 1M, and most preferably 0.1M to 0.8M.

As the coating method of the primary coating step and the secondary coating step, a method known in the art, for example, dip-coating, wash-coating, or the like may be used, but the coating method is not limited thereto.

The method for manufacturing a catalyst for methane reformation according to an exemplary embodiment of the present application further includes performing drying and firing after the secondary coating step. That is, the method further comprises performing drying and firing after the primary coating and the secondary coating are completed.

In this case, the drying may be performed at temperatures of 50° C. to 150° C. for 1 to 48 hours or at temperatures of 60° C. to 100° C. for 5 to 36 hours, but the conditions are not limited thereto.

In addition, the firing may be performed at temperatures of 350° C. to 1,100° C. for 1 to 10 hours under air atmosphere, or at temperatures of 500° C. to 1,000° C. for 1.5 to 8 hours under air atmosphere, but the conditions are not limited thereto.

In the method for manufacturing a catalyst for methane reformation according to an exemplary embodiment of the present application, details on the porous metal support, the perovskite-based catalyst component, and the like are the same as those described above.

The catalyst for methane reformation according to an exemplary embodiment of the present application supports the catalyst component on the porous metal support with high thermal conductivity, so it has such features that good activity can be exhibited even at a high space velocity during a methane reforming reaction and a long-term stable operation is possible without carbon deposition or sintering.

In an exemplary embodiment of the present application, the catalyst may be applied to a steam reforming process, a carbon dioxide (CO₂) reforming process, a catalytic partial oxidation process, an autothermal reforming process, a tri-reforming process or a mixed reforming process, and the methane reforming process is not particularly limited.

In an exemplary embodiment of the present application, the methane reforming process may include bringing a mixed raw material into contact with the catalyst according to the present application. The mixed raw material may be one including CH₄ and CO₂.

In an exemplary embodiment of the present application, the methane reforming process may include bringing a mixed raw material into contact with the catalyst according to the present application inside a reactor. The mixed raw material may be one including CH₄ and CO₂. The reactor may be a reactor commonly used in the relevant field.

In an exemplary embodiment of the present application, the methane reforming process may further include filling the reactor with the catalyst according to the present application; and subjecting the reactor filled with the catalyst to reduction condition of H₂/N₂.

In an exemplary embodiment of the present application, the step of subjecting the reactor filled with the catalyst to reduction condition of H₂/N₂ may include performing reduction at temperatures of 700° C. to 800° C. for 1 to 2 hours under condition of H₂/N₂.

In an exemplary embodiment of the present application, the condition of H₂/N₂ refers to a volume ratio of a volume of hydrogen (H₂) to a volume of nitrogen (N₂), and H₂/N₂ may satisfy 5% to 12%, and preferably 10%.

In an exemplary embodiment of the present application, for the methane reforming process, a commonly used methane reforming process except for using the catalyst for methane reformation of the present application may be applied.

### EXAMPLES

Below, Examples will be described in detail for specifically describing the present application. However, the Examples according to the present application may be modified in other forms, and the scope of the present application is not construed as being limited to the Examples described in detail below. The Examples of the present application are provided to more completely explain the present application to one skilled in the art.

### Examples

### 1) Example 1—Preparation of Catalyst for Methane Reformation

### (1) <Preparation Example 1>—Preparation of Primary Coating Layer

A SrTiO₃ (a=0 and δ=0 in Sr₁₋ₐYₐTiO_{3-δ} that is the Chemical Formula 3 of the present application) solution was prepared by the citrate method. Specifically, strontium nitrate (Sr(NO₃)₃H₂O) and yttrium(III) nitrate hexahydrate were dissolved in distilled water together with citric acid and ethylene glycol. After titanium isopropoxide (Ti(OCH(CH₃)₂)₄) was dissolved in ethanol, the two solutions were mixed at 70° C. Thereafter, the mixture was stirred for 3 hours to prepare a first solution (hereinafter, referred to as first slurry) containing SrTiO₃ (a=0 and δ=0 in Sr₁₋ₐAₐTiO_{3-δ}).

Subsequently, a porous metal support (NiFeCrAl) with a pore size of 800 μm was dip-coated with the first slurry solution (primary coating). Thereafter, the porous metal support was dried at 70° C. for 24 hours, and then heat-treated at 300° C. to 900° C. for 3 hours under air atmosphere to prepare a porous metal support (NiFeCrAl) coated with SrTiO₃ as a primary coating layer.

In this case, the content of SrTiO₃ was 7 wt % based on the total weight of the primary coating layer.

### (2) <Preparation Example 2>—Preparation of Secondary Coating Layer

Perovskite-based catalyst particles represented by SrTi_{0.90}Ni_{0.1}O_{3-δ} (B is Ni, x=0, and y=0.1 in Sr₁₋ₓAₓTi_{1-y}B_{y}O_{3-δ} that is Chemical Formula 1 of the present application) and perovskite-based catalyst particles represented by SrTi_{0.97}Ni_{0.03}O_{3-δ} (B is Ni, x=0, and y=0.03 in Sr₁₋ₓAₓTi_{1-y}B_{y}O_{3-δ} that is Chemical Formula 1 of the present application) were prepared by the citrate method.

Specifically, a solution containing a perovskite-based compound represented by SrTi_{0.90}Ni_{0.1}O_{3-δ} and a solution containing a perovskite compound represented by SrTi_{0.97}Ni_{0.03}O_{3-δ} were prepared, respectively, in the same manner as Preparation Example 1, except that in Preparation Example 1, a first solution was prepared by adding a certain amount of nickel nitrate (Ni(NO₃)₂) so that the content of nickel (Ni) and the content of titanium (Ti) were 10 mol % and 3 mol % compared to the sum of nickel (Ni) and titanium (Ti), respectively.

The solution containing the perovskite-based compound represented by SrTi_{0.90}Ni_{0.1}O_{3-δ} prepared by the above method was dried at 70° C. for 24 hours and then heat-treated at 900° C. for 3 hours in an air atmosphere to prepare perovskite-based catalyst particles represented by SrTi_{0.90}Ni_{0.1}O_{3-δ}.

In addition, the solution containing the perovskite-based compound represented by SrTi_{0.97}Ni_{0.03}O_{3-δ} prepared by the above method was added with water so that the concentration of the perovskite-based compound represented by SrTi_{0.97}Ni_{0.03}O_{3-δ} became 0.25M, and mixed to prepare a perovskite-based binder represented by SrTi_{0.97}Ni_{0.03}O_{3-δ}.

In this case, a second solution (hereinafter, a second slurry) was prepared by mixing the perovskite-based catalyst particles and the perovskite-based binder so that the content of the perovskite-based catalyst particles became 5 wt % based on the total amount of the perovskite-based catalyst particles and the perovskite-based binder.

Subsequently, the porous metal support (NiFeCrAl) coated with SrTiO₃ as the primary coating layer of Preparation Example 1 was dip-coated with the second slurry (secondary coating), and then excess slurry was removed from the porous metal support using a blower.

Thereafter, the porous metal support was dried at 70° C. for 1 hour to remove the solvent component, and then heat-treated at 900° C. for 5 hours under air atmosphere to prepare a catalyst for methane reformation including the primary coating layer including SrTiO₃ and the secondary coating layer including the perovskite-based catalyst particles represented by SrTi_{0.90}Ni_{0.1}O_{3-δ} and the perovskite-based catalyst binder represented by SrTi_{0.97}Ni_{0.03}O_{3-δ}. In this case, the amount of catalyst coated once was 3.5 wt %, and the secondary coating was repeated to finally prepare the catalyst for methane reformation of Example 1 (content of the supported catalyst based on the total weight of the catalyst for methane reformation: 14.8%).

Information on the type of porous metal support used in Example 1, the material included in the primary coating layer and the material included in the secondary coating layer, and information on the content of the support catalyst based on the total weight of the catalyst for methane reformation. are listed in Table 1 below.

### 2) Examples 2 to 9 and Comparative Examples 1 to 10

Catalysts of Examples 2 to 9 and Comparative Examples 1 to 10 were prepared, respectively, in the same manner as Example 1, except that in the preparation method of a catalyst for methane reformation of Example 1, the catalysts were prepared to have the contents of the catalysts listed in Table 1 below by using the porous metal supports listed in Table 1 below as the porous metal support and the materials listed in Table 1 below as the materials of the primary coating layer and the secondary coating layer.

For example, Comparative Example 4 can be construed as having a porous metal support (NiFeCrAl) that is not formed with the primary coating layer and the secondary coating layer.

For reference, in Table 1 below, materials A and B used for the primary coating layer and the secondary coating layer were prepared by the citrate method used in Preparation Example 1 or Preparation Example 2. Specifically, when applying the citrate method, a solution prepared to satisfy each composition ratio was used. When adding yttrium (Y), yttrium nitrate (Y(NO₃)₂) was added, and when adding ruthenium (Ru), ruthenium chloride monohydrate (RuCl₃H₂O) was added.

TABLE 1

| | Porous metal support | | Primary coating layer | |
|---|---|---|---|---|
| | Type | Pore size (μm) | Material A | Content A (wt %) |
| Example 1 | NiFeCrAl | 800 | SrTiO₃ | 7 |
| Example 2 | NiFeCrAl | 1200 | SrTiO₃ | 10 |
| Example 3 | NiFeCrAl | 1200 | Sr_{0.9}Y_{0.1}TiO₃ | 5 |
| Example 4 | NiFeCrAl | 1200 | Sr_{0.85}Y_{0.15}TiO₃ | 15 |
| Example 5 | NiCrAl | 800 | SrTiO₃ | 3 |
| Example 6 | NiCrAl | 1200 | Sr_{0.95}Y_{0.05}TiO₃ | 5 |
| Example 7 | NiCrAl | 1500 | Sr_{0.9}Y_{0.1}TiO₃ | 10 |
| Example 8 | NiFeCrAl | 1200 | SrTiO₃ | 15 |
| Example 9 | NiCrAl | 1500 | Sr_{0.9}Y_{0.1}TiO₃ | 20 |
| Comparative | NiFeCrAl | 800 | SrTiO₃ | 7 |
| Example 1 | | | | |
| Comparative | NiCrAl | 1200 | SrTi_{0.97}Ni_{0.03}O_{3-δ} | 15.3 |
| Example 2 | | | | |
| Comparative | NiCrAl | 1200 | Al₂O₃ | 10 |
| Example 3 | | | | |
| Comparative | NiFeCrAl | 800 | — | — |
| Example 4 | | | | |
| Comparative | NiFeCrAl | 800 | — | — |
| Example 5 | | | | |
| Comparative | NiFeCrAl | 800 | SrTiO₃ | 7 |
| Example 6 | | | | |
| Comparative | NiFeCrAl | 1200 | SrTiO₃ | 10 |
| Example 7 | | | | |
| Comparative | NiFeCrAl | 800 | SrTiO₃ | 7 |
| Example 8 | | | | |
| Comparative | NiFeCrAl | 1200 | SrTiO₃ | 10 |
| Example 9 | | | | |
| Comparative | NiFeCrAl | 800 | Al₂O₃ | 7 |
| Example 10 | | | | |

| | Secondary coating layer (Nth coating) | | | | | Supported | |
|---|---|---|---|---|---|---|---|
| | Catalyst particle | | Binder | | | amount | |
| | | Content B | | Concentration | | during one | Content of |
| | Material B | (wt %) | Type | (M) | Solvent | coating (%) | cataylst [%] |
| Example 1 | SrTi_{0.90}Ni_{0.1}O_{3-δ} | 5 | SrTi_{0.97}Ni_{0.03}O_{3-δ} | 0.25 | water | 3.7 | 14.8 |
| Example 2 | SrTi_{0.95}Ni_{0.05}O_{3-δ} | 20 | SrTi_{0.97}Ru_{0.03}O_{3-δ} | 0.1 | water | 3.3 | 16.5 |
| Example 3 | Sr_{0.9}Y_{0.1}Ti_{0.9}Ru_{0.1}O_{3-δ} | 10 | Sr_{0.9}Y_{0.1}Ti_{0.95}Ni_{0.05}O_{3-δ} | 0.4 | ethanol | 10.5 | 21.0 |
| Example 4 | Sr_{0.85}Y_{0.15}Ti_{0.85}Ni_{0.15}O_{3-δ} | 15 | Sr_{0.95}Y_{0.05}Ti_{0.93}Ni_{0.07}O_{3-δ} | 0.6 | water | 13.2 | 13.2 |
| Example 5 | Sr_{0.9}Y_{0.1}Ti_{0.93}Ru_{0.7}O_{3-δ} | 15 | Sr_{0.9}Y_{0.1}Ti_{0.93}Ru_{0.7}O_{3-δ} | 0.15 | water | 3.1 | 18.6 |
| Example 6 | Sr_{0.85}Y_{0.15}Ti_{0.9}Ni_{0.1}O_{3-δ} | 13 | SrTi_{0.95}Ni_{0.05}O_{3-δ} | 0.3 | ethanol | 9.1 | 18.2 |
| Example 7 | SrTi_{0.94}Ni_{0.06}O_{3-δ} | 10 | Sr_{0.95}Y_{0.05}Ti_{0.95}Ni_{0.05}O_{3-δ} | 0.1 | water | 3.4 | 17.0 |
| Example 8 | Sr_{0.9}Y_{0.1}Ti_{0.9}Ni_{0.1}O_{3-δ} | 10 | Sr_{0.9}Y_{0.1}Ti_{0.95}Ni_{0.05}O_{3-δ} | 0.3 | water | 4.5 | 18 |
| Example 9 | Sr_{0.9}Y_{0.1}Ti_{0.85}Ni_{0.15}O_{3-δ} | 5 | Sr_{0.9}Y_{0.1}Ti_{0.85}Ni_{0.15}O_{3-δ} | 0.25 | water | 3.2 | 16.0 |
| Comparative | — | — | — | — | — | — | — |
| Example 1 | | | | | | | |
| Comparative | — | — | — | — | — | 1.3 | 15.3 |
| Example 2 | | | | | | | |
| Comparative | — | — | — | — | — | — | — |
| Example 3 | | | | | | | |
| Comparative | — | — | — | — | — | — | — |
| Example 4 | | | | | | | |
| Comparative | SrTi_{0.97}Ni_{0.03}O_{3-δ} | 10 | SrTi_{0.97}Ni_{0.03}O_{3-δ} | 0.3 | water | 4.8 | 14.4 |
| Example 5 | | | | | | | |
| Comparative | SrTi_{0.2}Ni_{0.8}O_{3-δ} | 5 | SrTi_{0.97}Ni_{0.03}O_{3-δ} | 0.25 | water | 3.6 | 14.4 |
| Example 6 | | | | | | | |
| Comparative | SrTi_{0.95}Ni_{0.05}O_{3-δ} | 20 | SrTi_{0.4}Ru_{0.6}O_{3-δ} | 0.1 | water | 3.5 | 17.5 |
| Example 7 | | | | | | | |
| Comparative | SrTi_{0.90}Ni_{0.1}O_{3-δ} | 5 | — | — | — | — | — |
| Example 8 | | | | | | | |
| Comparative | — | — | SrTi_{0.97}Ru_{0.03}O_{3-δ} | 0.3 | water | 0.8 | 16.8 |
| Example 9 | | | | | | | |
| Comparative | SrTi_{0.90}Ni_{0.1}O_{3-δ} | 5 | SrTi_{0.97}Ni_{0.03}O_{3-δ} | 0.25 | water | 3.6 | 14.4 |
| Example 10 | | | | | | | |

In Table 1, content A refers to the content (%) of material A in Table 1 included based on the total weight of the primary coating layer. Content B refers to the content of material B in Table 1 included based on the total amount of the perovskite-based catalyst particles and perovskite-based binder (total amount of the second slurry), and the content of catalyst refers to the content (%) of catalyst supported on the metal structure based on the total weight of the catalyst for methane reformation. Specifically, the supported catalyst refers to the amount of the perovskite-based compound supported on the metal structure.

In addition, the pore size in Table 1 refers to the average pore size.

Lastly, in Table 1, the supported amount (%) during one coating refers to the content (%) of the perovskite structure compound supported on the catalyst during one coating based on the total weight of the catalyst for methane reformation, in the process of repeatedly performing the coating of the secondary coating layer in order to satisfy the content of catalyst in Table 1, i.e., in order to satisfy the amount of the perovskite structure compound supported on the metal structure. In this case, the amount of the perovskite structure compound supported on the metal structure refers to a total of the perovskite-based compound of the primary coating layer and the perovskite structure compound included in the perovskite-based catalyst particles and perovskite-based binder included in the secondary coating layer.

Here, the perovskite structure compound refers to a compound satisfying the following Chemical Formula A.

Sr₁₋ₓAₓTi_{1-y}B_{y}O_{3-δ} [Chemical Formula A]
wherein, in Chemical Formula A,
A is Y, La or Ba,
B is Ni, Co, Fe, Mn, Cr, Mo, Ru or Rh,
x is 0≤x<1,
y is 0≤y<1,
δ is a value that satisfies balance, 0≤δ<1, and
the x and y satisfy x+y>0.

Accordingly, in Table 1, in the case of Comparative Examples 1, 3, and 4 in which the compound represented by Chemical Formula A was not included in neither the primary coating layer nor the secondary coating layer, the supported amount (%) during one coating and the content of catalyst were not described, and in the case of Comparative Example 8 in which the compound represented by Chemical Formula A was included as catalyst particles (material B) in the secondary coating layer but no binder was included, so the secondary coating layer was not properly attached to the porous metal support and was thus not supported, the supported amount (%) during one coating and the content of the catalyst were not described.

In the case of Comparative Example 9 in which only a binder was included in the secondary coating layer, it can be confirmed that the supported amount (%) during one coating was very small, as compared with the Examples. That is, it could be confirmed that when the secondary coating layer includes only the binder according to the present application without the catalyst particles according to the present application, it takes a lot of time and cost to prepare the catalyst.

Thereafter, the durability of the catalysts of Examples and Comparative Examples in Table 1 were evaluated at 800° C. that is a reaction temperature of the dry reforming reaction of methane. As a result, no cracks were found in the catalysts of Examples 1 to 9, but some cracks were found in the catalysts of Comparative Examples 2 to 5.

In this regard, referring to Table 2 below, regarding the materials used in the catalysts of the Examples of Table 1, it could be confirmed that the primary coating layer included the perovskite-based compound with a coefficient of thermal expansion of 65% or greater compared to a coefficient of thermal expansion of the porous metal support.

In addition, it could be confirmed that the perovskite-based compound with the coefficient of thermal expansion of 65% or greater compared to the coefficient of thermal expansion of the porous metal support satisfies the following Equation 1.

$$10. \times {10}^{- 6} {K}^{- 1} \leq G 1 \leq 14. \times {10}^{- 6} {K}^{- 1} \qquad [ Equation 1 ]$$

in Equation 1, G1 refers to a coefficient of thermal expansion.

That is, it could be confirmed that the catalysts of Examples 1 to 9 had excellent durability at high temperatures because a difference between the coefficient of thermal expansion of the porous metal support and the coefficient of thermal expansion of the perovskite-based compound included in the primary coating layer was not large.

TABLE 2

| | Coefficient of |
|---|---|
| | thermal expansion |
| Material | (10⁻⁶ × 1/K) |
| SrTiO₃ | 12.2 |
| Sr_{0.85}Y_{0.15}TiO₃ | 11.3 |
| Sr_{0.95}Y0_{.05}TiO₃ | 11.1 |
| Sr_{0.9}Y_{0.1}TiO₃ | 10.9 |
| Al₂O₃ | 9.2 |
| NiCrAl | 15.9 |
| NiFeCrAl | 15.7 |

### Experimental Example—Evaluation of Dry Reforming Reaction of Methane

A fixed-bed reactor system was introduced to carry out a dry reforming reaction of methane. A Quartz tube reactor (inner diameter=½ inch, length=50 cm) was used and packed with each catalyst for methane reformation (about 2 g) listed in Table 3 below.

After the catalyst underwent a reduction process at 800° C. for 1 to 2 hours under conditions of 10% H₂/N₂, a catalytic reaction was performed for 100 hours.

Thereafter, the activity characteristics of the catalysts were evaluated while carrying out the reaction with satisfying the following conditions. For reference, the following conditions were set to evaluate the activity characteristics of the catalysts at severe space velocity in order to more clearly compare the difference in activity between catalysts.

### Experimental Conditions

Gas composition: CH₄:CO₂:N₂=1:1.2:0.96
Flow rate: gas hour space velocity (GHSV)=1,500 hr⁻¹ (based on CH₄)
Reaction temperature: 800° C.
Reaction pressure: 1 bar

Then, a reaction conversion rate after 100 hours of reaction was calculated by analyzing the composition of the produced gas using gas chromatography (GC), and is shown in the following Table 3.

### <GC Analysis Conditions>

1) GC model: Agilent 6890
2) Oven temperature: 40° C./7 min-90° C./5 min-180° C./6 min 3) Detector: TCD, 250° C.
4) Sample loop: 0.25 mL
5) Valve box Temp.: 150° C.

TABLE 3

| | CH₄ | CO₂ | |
|---|---|---|---|
| | Conversion | Conversion | |
| Catalyst | rate (%) | rate (%) | H₂/CO |
| Example 1 | 60 | 68 | 0.77 |
| Example 2 | 46 | 53 | 0.76 |
| Example 3 | 61 | 69 | 0.78 |
| Example 4 | 58 | 65 | 0.77 |
| Example 5 | 59 | 67 | 0.78 |
| Example 6 | 60 | 69 | 0.78 |
| Example 7 | 48 | 56 | 0.76 |
| Example 8 | 60 | 68 | 0.77 |
| Example 9 | 46 | 53 | 0.76 |
| Comparative | 2 | 4 | 0.18 |
| Example 1 | | | |
| Comparative | 42 | 54 | 0.73 |
| Example 2 | | | |
| Comparative | 2 | 5 | 0.15 |
| Example 3 | | | |
| Comparative | 22 | 24 | 0.57 |
| Example 4 | | | |
| Comparative | 41 | 50 | 0.71 |
| Example 5 | | | |
| Comparative | 68 | 78 | 0.70 |
| Example 6 | | | |
| Comparative | 59 | 62 | 0.71 |
| Example 7 | | | |
| Comparative | 2 | 4 | 0.18 |
| Example 8 | | | |
| Comparative | 43 | 50 | 0.76 |
| Example 9 | | | |
| Comparative | 62 | 70 | 0.77 |
| Example 10 | | | |

The conversion rate in Table 3 was calculated using Equation 2 below.

$$Conversion rate ( Xi , \% ) = [ \text{} ( Fin - Fiout ) / Fiin ] \times 100 ( \% ) ( Fi = flow rate of i ) \qquad [ Equation 2 ]$$

As can be seen from the results in Table 3, it could be confirmed that the catalysts of Examples 1 to 9 had high CH₄ conversion rate (%) and CO₂ conversion rate (%), as compared with the catalysts of the Comparative Examples.

In particular, when compared with the catalysts of Comparative Examples 1 to 4 without a secondary coating layer, it could be confirmed that the catalysts of Examples 1 to 9 had higher CH₄ conversion rate (%) and CO₂ conversion rate (%).

In addition, when compared with the catalyst of Comparative Example 5 without a primary coating layer, it could be confirmed that the catalysts of Examples 1 to 9 had higher CH₄ conversion rate (%) and CO₂ conversion rate (%).

In the case of Comparative Example 8 in which the secondary coating layer included the catalyst particles according to the present application but did not include the binder itself, it could be confirmed that no binder was included, so the secondary coating layer was not properly attached to the porous metal support, and accordingly, the CH₄ conversion rate (%) and CO₂ conversion rate (%) were very low and the catalyst did not function as a catalyst for methane reformation.

In addition, in Comparative Example 9, the performance of the prepared catalyst may be at a similar level to that of the Examples. However, as described above, like Comparative Example 9, when the secondary coating layer includes the binder according to the present application but does not include the catalyst particles according to the present application, it could be confirmed that the supported amount (%) during one coating was very small, so it took a lot of time and cost to prepare the catalyst.

Additionally, the degree of coke generation in Examples 1 to 7 and Comparative Examples 6 and 710, which had similar CH₄ conversion rates and CO₂ conversion rates as a result of the reaction, was measured. Specifically, the degree of coke generation was calculated using Equation 3 below, and the results are shown in Table 4 below.

For reference, the larger the value calculated by Equation 3 below, the more the amount of coke generated.

$$coke generation rate ( \% ) = [ weight of catalyst after reaction - weight of catalyst before reaction ) \text{} / weight of catalyst before reaction ] \times 100 ( \% ) \qquad [ Equation 3 ]$$

TABLE 4

| | Coke |
|---|---|
| | generation |
| | rate (%) |
| Example 1 | 0.4 |
| Example 2 | 0.0 |
| Example 3 | 0.4 |
| Example 4 | 0.3 |
| Example 5 | 0.4 |
| Example 6 | 0.4 |
| Example 7 | 0.0 |
| Comparative | 6.5 |
| Example 6 | |
| Comparative | 3.1 |
| Example 7 | |
| Comparative | 2.8 |
| Example 10 | |

As can be seen from the results in Table 4, it could be confirmed that the catalyst according to the present application had a significantly low coke generation rate. In particular, when compared with the catalyst of the present application, it could be confirmed that the coke generation rate was very high in Comparative Examples 6 and 7 in which the content of Ti was significantly small. This is thought to be a phenomenon that occurs because a perovskite structure whose content of Ti is very small is not formed well and Ni exists in the form of bulk.

Therefore, it could be confirmed from the results of Table 4 that the catalyst according to the present application can prevent the problem that the nickel catalyst is deactivated by carbon generated on the surface of the nickel catalyst during reaction at high temperatures, when compared with the catalysts of the Comparative Examples in which the CH₄ conversion rates (%) and CO₂ conversion rates (%) were similar. This means that the catalyst of the present application has durability at high temperatures, so there is an advantage in that the catalyst can be used for a long time during the reaction at high temperatures.

In conclusion, it could be confirmed that the catalyst of this application has excellent durability at high temperatures as described above and high catalyst activity.

1. A catalyst for methane reformation, comprising:
a porous metal support;
a primary coating layer provided on the porous metal support; and
a secondary coating layer provided on the primary coating layer,
wherein the primary coating layer comprises a perovskite-based compound a coefficient of thermal expansion of 65% or greater compared to a coefficient of thermal expansion of the porous metal support,
wherein the secondary coating layer comprises a perovskite-based catalyst particle and a perovskite-based binder, and
wherein the perovskite-based catalyst particle and the perovskite-based binder each independently comprise a compound represented by Chemical Formula 1,
Sr₁₋ₓAₓTi_{1-y}B_{y}O_{3-δ} [Chemical Formula 1]
in Chemical Formula 1,
A is Y, La or Ba,
B is Ni, Co, Fe, Mn, Cr, Mo, Ru or Rh,
0≤x<1,
0≤y<0.5,
0≤δ<1, and
x+y>0.

2. The catalyst of claim 1, wherein the perovskite-based compound is represented by Chemical Formula 3:
Sr₁₋ₐYₐTiO_{3-δ} [Chemical Formula 3]
in Chemical Formula 3,
0≤a<1, and
0≤δ<1.

3. The catalyst of claim 1, wherein the compound represented by Chemical Formula 1 is represented by Chemical Formula 2:
Sr₁₋ₓYₓTi_{1-y}B_{y}O_{3-δ} [Chemical Formula 2]
in Chemical Formula 2,
B is Ni, Co, Fe, Mn, Cr, Mo, Ru or Rh,
0≤x<0.3,
0≤y<0.2,
0≤δ<1, and
x+y>0.

4. The catalyst of claim 3, wherein B in Chemical Formula 2 is Ni or Ru.

5. The catalyst of claim 1, wherein the porous metal support comprises at least one of NiCrAlFe, NiCrAl, stainless steel, and or inconel.

6. The catalyst of claim 1, wherein a content of the perovskite-based catalyst particle and the perovskite-based binder is 3% by weight to 40% by weight, based on a total weight of the catalyst.

7. The catalyst of claim 1, wherein a concentration of the perovskite-based compound binder is 0.05M to 1M.

8. The catalyst of claim 1, which is applied to a steam reforming process, a carbon dioxide (CO₂) reforming process, a catalytic partial oxidation process, an autothermal reforming process, a tri-reforming process, or a mixed reforming process thereof.

9. A method for manufacturing a catalyst for methane reformation, the method comprising:
performing primary coating on a porous metal support with a first slurry comprising a perovskite-based compound having a coefficient of thermal expansion of 65% or greater compared to a coefficient of thermal expansion of the porous metal support; and
performing secondary coating with a second slurry comprising a perovskite-based catalyst particle and a perovskite-based binder after the primary coating,
wherein the perovskite-based catalyst particle and the perovskite-based binder each independently comprise a compound represented by Chemical Formula 1,
Sr₁₋ₓAₓTi_{1-y}B_{y}O_{3-δ} [Chemical Formula 1]
in Chemical Formula 1,
A is Y, La or Ba,
B is Ni, Co, Fe, Mn, Cr, Mo, Ru or Rh,
0≤x<1,
0≤y<0.5,
0≤δ<1, and
x+y>0.

10. The method of claim 9, wherein the perovskite-based compound is represented by Chemical Formula 3:
Sr₁₋ₐYₐTiO_{3-δ} [Chemical Formula 3]
in Chemical Formula 3,
0≤a<1, and
0≤δ<1.

11. The method of claim 9, wherein the compound represented by Chemical Formula 1 above is represented by Chemical Formula 2 below:
Sr₁₋ₓYₓTi_{1-y}B_{y}O_{3-δ} [Chemical Formula 2]
in Chemical Formula 2,
B is Ni, Co, Fe, Mn, Cr, Mo, Ru or Rh,
0≤x<0.3,
0≤y<0.2,
0≤δ<1, and
x+y>0.

12. The method of claim 11, wherein B in Chemical Formula 2 is Ni or Ru.

13. The method of claim 9, wherein the porous metal support comprises at least one selected of NiCrAlFe, NiCrAl, stainless steel, or inconel.

14. The method of claim 9, wherein a content of the perovskite-based catalyst particle and the perovskite-based binder is 3% by weight to 30% by weight, based on a total weight of the catalyst.

15. The method of claim 9, wherein a concentration of the perovskite-based compound binder is 0.05M to 1M.

16. The catalyst of claim 1, wherein a content of the perovskite-based compound is 1% by weight to 20% by weight based on a total weight of the catalyst.

17. The catalyst of claim 1, wherein the perovskite-based compound is SrTiO₃.

18. The catalyst of claim 1, wherein at least a portion of a surface of the perovskite-based catalyst particle includes a protrusion shape.

19. The catalyst of claim 1, wherein the perovskite-based binder is present in a form of protrusion on the perovskite-based catalyst particle.

20. The method of claim 9, wherein the first slurry does not comprise a binder.
